(19) United States
(12) Patent Application Publication
(10) Pub. No.: US 2026/0222736 A1
(43) Pub. Date: Jul. 30, 2026

(54) Audio system comprising a head wearable carrier element configured with a beam forming loudspeaker system

(71) Applicant: TK&H Holding AS, Tjøme (NO)

(72) Inventors: Tom Austad, Tjøme (NO); Hans Zwart, Apeldoorn (NL)

(73) Assignee: TK&H Holding AS, Tjøme (NO)

(21) Appl. No.: 19/146,086

(22) PCT Filed: Jan. 5, 2024
(86) PCT No.: PCT/EP2024/050211

§ 371 Date: Jul. 7, 2025

(30) Foreign Application Priority Data
Jan. 6, 2023 (NO) 20230010

(51) Int. Cl. H04R 3/12; G02C 11/00; H04R 1/10; H04R 1/40

(52) U.S. Cl. CPC H04R 3/12; G02C 11/10; H04R 1/1008; H04R 1/1041; H04R 1/1075; H04R 1/403; H04R 2420/07

(57) ABSTRACT

The resent invention is related to a head wearable carrier system (10) configured with a beam forming loudspeaker system (16), wherein the carrier system (10) is configured to arrange the beam forming loudspeaker system (16, 16a, 16b) in proximity of a side of at least one ear (14) when in use, wherein beamformed audio signals (15) are directed towards an ear channel opening (18) of the at least one ear (14).

### FIELD OF THE INVENTION

The present invention relates to an audio system comprising a head wearable carrier element configured with a beam forming loudspeaker system, wherein the beamforming is configurable enabling transfer of audio signals directed towards an ear channel opening of a user wearing the system.

### BACKGROUND OF THE INVENTION

The ability to listen to music when walking outdoors was probably made possible for most people when the so called Walkman was introduced in the market around 1979 by Sony. Today mobile phones can serve as a mobile entertainment system including playing music.

A common feature of mobile phones is wireless earbuds or headphones used when listening to music or speech. The patent application WO 2021/165238 by the same inventors as the present invention disclose a hearing aid system integrated into an eyeglass frame comprising multiple microphones controlled by a digital signal processor providing beamforming of the microphones. Audio signals received by the hearing aid system is transmitted wirelessly to earbuds inserted into respective ear channel openings of a user of the system.

Earbuds or headphones communicating wirelessly with a mobile phone is a common solution in prior art. However, one problem may be that the earbuds or headphones mask other sound sources in the surrounding of a user of such equipment. This may be a problem for example when walking or driving in an area with traffic. Especially pedestrians should be able to hear a car that is approaching their position when being outdoors.

In prior art there are some examples of alternative solutions to wireless transfer of audio signals to a human ear channel opening.

For example, U.S. Pat. No. 1,148,366 B2 disclose a bone conduction speaker and its compound vibration device. The compound vibration device comprises a vibration conductive plate and a vibration board, the vibration conductive plate is set to be the first torus, where at least two first rods inside the conductive plate converge to its center; the vibration board is set as the second torus, where at least two second rods inside the vibration board converge to its center. The vibration conductive plate is fixed with the vibration board; the first torus is fixed on a magnetic system, and the second torus comprises a fixed voice coil, which is driven by the magnetic system. The bone conduction speaker in the present disclosure and its compound vibration device adopt the fixed vibration conductive plate and vibration board, making the technique simpler with a lower cost; because the two adjustable parts in the compound vibration device can adjust both low frequency and high frequency area, the frequency response obtained is flatter and the sound is broader.

WO 2017/144269 discloses an audio system arrangeable in the outer region of an ear comprising a carrier element attachable to the head of a user. The audio system comprises a cavity with a primary opening pointing towards an ear channel opening when mounted onto a head of a user. The cavity is arranged with a loudspeaker and audio sound which is then transmitted from the loudspeaker and guided via the cavity towards an ear channel opening. The audio system can for example be arranged inside a temple of an eyeglass frame.

However, user control of the transmitted audio signal towards an ear channel opening is beneficial for example to be able to improve audio quality of received audio signals. For example, with reference to WO 2017/144269, the received audio quality depends on how well the primary opening of the cavity is directed towards an ear channel opening. When installed in an eyeglass frame the relative position of the eyeglass frame relative to an ear channel opening may vary from one person to another, for example between adults and children. This should be controllable providing better audio quality during use, or also lower the received audio signal power if the received audio signal competes or is blocking other audio signals from the surroundings of a user the user needs or want to receive with improved quality.

Therefore, there is a need of a loudspeaker system that can transmit audio signals to an ear channel opening, wherein the audio signal direction, signal power etc. when transmitted from the loudspeaker system should be user controllable.

### OBJECT OF THE INVENTION

It is an object of the present invention to provide an alternative to the prior art.

In particular, it may be seen as an object of the present invention to provide improved reception of audio signals from respective loudspeakers arranged in an array configured to provide beamforming.

### SUMMARY OF THE INVENTION

Thus, the above-described object and several other objects are intended to be obtained in a first aspect of the invention by providing a wearable carrier system configured with a loudspeaker beamforming system.

The invention is particularly, but not exclusively, advantageous for obtaining A head wearable carrier system configured with a beam forming loudspeaker system,
wherein the carrier system is configured to locate the beam forming loudspeaker system in proximity of a side of at least one ear when in use,
wherein beamformed audio signals are directed towards an ear channel opening of the at least one ear.

Respective aspects of the present invention may each be combined with any of the other aspects. These and other aspects of the invention will be disclosed and elucidated with reference to the embodiments described herein.

### DESCRIPTION OF THE FIGURES

FIG. 1 illustrates an example of embodiment of the present invention.

FIG. 2 illustrates anatomy details of an outer human ear.

FIG. 3 illustrates another example of embodiment of the present invention.

### DETAILED DESCRIPTION OF AN EMBODIMENT

Although the present invention is disclosed in connection with specific examples of embodiments, it should not be construed as being in any way limited to the presented examples. The accompanying claim set defines the scope of protection of the present invention. In the context of the claims, the terms “comprising” or “comprises” do not exclude other possible elements or steps. Further, the mentioning of references such as “a” or “an” etc. should not be construed as excluding a plurality. The use of reference signs in the claims with respect to elements indicated in the figures shall also not be construed as limiting the scope of the invention.

Furthermore, combining individual features mentioned in different claims may possibly be advantageously, and the mentioning of these features in different claims does not exclude that a combination of features is not possible and advantageous.

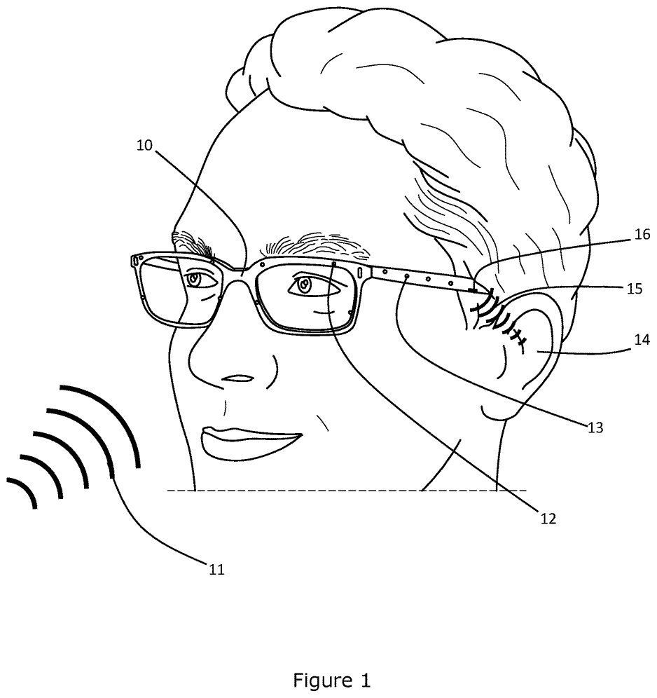

FIG. 1 illustrates an example of embodiment of the present invention. In this example of embodiment, the audio system comprises a head wearable carrier element embodied as an eye glass frame 10. The eyeglass frame 10 is almost identical to the hearing aid system disclosed in WO 2021/165238 by the same inventors as the present invention. Sound 11 from for example other people is received by a plurality of microphones 12, 13 which are configured and controlled by a digital signal processor supervised by an embedded SOC (System-On a Chip) arranged inside the eyeglass frame 10. The system provides for example beam forming of an array of microphones 12, 13 making it possible to enhance reception of audio signals. Received audio input 11 is then according to WO 2021/165238 transmitted wirelessly to adapted earbuds inserted into ear channel openings.

The difference between the eyeglass frame of WO 2021/165238 and the eyeglass frame 10 depicted in FIG. 1 of the present invention is that there is an array of loudspeakers 16 comprising at least two loudspeakers controllable to achieve beamforming of the loudspeaker audio output 15 and is configured to transmit the audio signals 15 towards an ear 14. In the example of embodiment disclosed in FIG. 1 the loudspeaker array is arranged on a temple of the eyeglass frame 10 in proximity of the part of the temple resting on an ear body. The audio waves transmitted from the loudspeaker array 16 spreads outwards in all direction, but when the beamforming of the loudspeaker array 16 is active most of the audio wave power reach the ear 14. It is therefore beneficial, but not essential, that there is a free line of sight between the loudspeaker array 16 and an opening of an ear channel the loudspeaker beam is directed towards.

The eyeglass frame 10 may also be configured with a wireless interface enabling communication with for example a mobile phone. The eyeglass frame may then be configured to transmit audio signals from the mobile phone to the loudspeaker array 16.

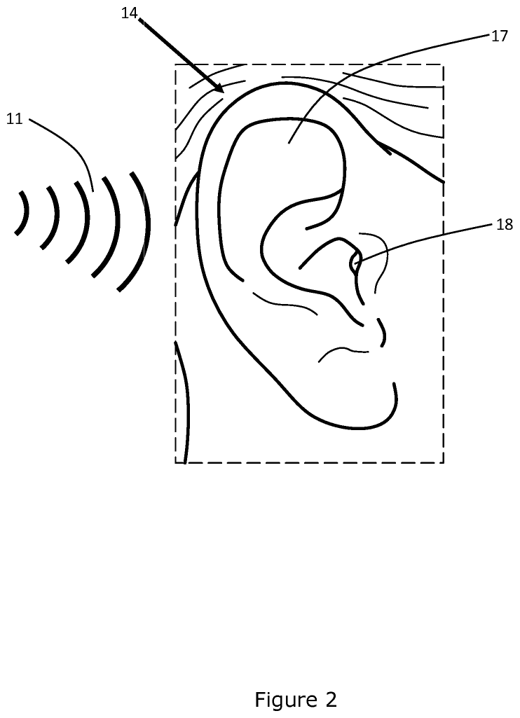

FIG. 2 illustrate anatomic parts of an outer ear-part 14. A soundwave 11 is approaching the visible part 14 called the pinna. The pinna collects sound waves and channel them towards the ear channel opening 18 (external auditory meatus) which amplifies sound waves before the sound waves hits the eardrum of the ear.

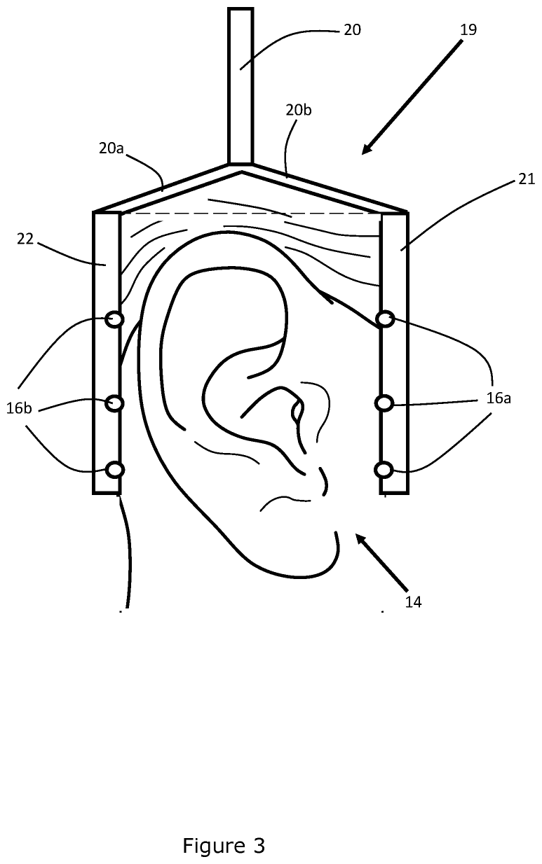

Another example of embodiment of the present invention is illustrated in FIG. 3.

In this example of embodiment of the present invention a carrier element 19 supporting a loudspeaker array is embedded as a headset comprising a first member 21 and a second member 22 configured to be running in parallel and in proximity of respective sides of an ear 14 when attached to a head. The carrier element 19 comprises a support element 20 resting on a head of a user when in use. The first and second member 21, 22 are supported by the support element 20 via a respective first and second arm 20a, 20b running out from a bottom end of the attachment element 20.

The first member 21 is arranged with a loudspeaker array 16a illustrated in this example with three loudspeaker elements. The second member 22 is arranged with a loudspeaker array 16b comprising for example three loudspeaker elements.

In this example of embodiment, the carrier element 19 may comprise for example a blue tooth interface enabling wireless transfer of audio signals to the headset. Respective members 21, 22 may for example be arranged with a digital signal processor enabling beamforming of for example stereo sound towards an ear channel opening of an ear 14.

It is also within the scope of the example of embodiment illustrated in FIG. 3 to attach a microphone on an arm attached to the headset 19 enabling a positioning of the microphone in front of a user's mouth (not illustrated). The audio signal from the microphone may be mixed with the external audio signals received wirelessly from other audio sources and transmitted via the respective loudspeaker arrays 16a, 16b to the ear channel opening.

The beneficial effect of this example of embodiment is the possibility that sound from the surroundings of a person using the headset 19 can be heard by the user in addition to sound transmitted wirelessly and/or from an attached microphone. An example may be when reporting from a football match. Then cheers from the audience can be rather loud. Wireless voice communication from a control center of a TV station can for example also be received wirelessly by the reporter wearing the headset 19.

It is also within the scope of the present invention enabling an eyeglass frame 10 illustrated in FIG. 1 as an alternative to the loudspeaker array 16, transmitting the audio signals wirelessly to an exemplar of the headset 19.

Beamforming of loudspeakers is a known signal processing technique in prior art providing a directional signal transmission from an array of loudspeakers receiving a same signal input. Controlling the relative phase and amplitude difference between the respective loudspeakers may make it is possible to shape the emission pattern of respective audio signals, for example shaping the audio signals to hit the ear channel input 18 illustrated in FIG. 2 with an improved and directed signal power.

Beamforming algorithms of sound beams from loudspeaker arrays enables for example a possible control of output volumes, direction of sound beams, shape of beams etc. by for example using cancelation techniques and/or delaying of a same respective audio signal transmitted to the respective loudspeakers of the loudspeaker array.

An example of an audio beamforming system may consist of a loudspeaker array wherein each sloudspeaker is controlled by a digital signal processor (DSP). The DSP uses for example a finite impulse filter (FIR) and/or other signal processing algorithms to control the respective loudspeaker outputs.

For example, a specific set of FIR filter coefficients can produce a desired volume of an acoustic signal at a specific point in space of a room.

When expressing such a system mathematically, it is possible to establish a first matrix that describes the sound propagation of each individual speaker in the system in each individual direction (an M×N matrix) at different frequencies ω. Respective coefficients describing respective loudspeakers may be arranged in a second matrix. Then the total response of the system can be expressed as a matrix multiplication of the first and second matrix.

When a target response is chosen, for example in front of an ear channel opening, the difference between the total system response and the target response can be minimized and it is possible to identify the correct FIR filter coefficients.

The calculations are time consuming, and it is therefore within the scope of the present invention to pre-calculate for example FIR coefficients related to different locations of a loudspeaker array and respective ear channel openings 18 (refer FIG. 2).

For example, anatomic differences between children and grown up people etc. can be accounted for. It is also within the scope of the present invention to pre-calculate different target volumes when a beamforming algorithm allows audio volume control. Respective FIR parameter settings for a specific beamforming can for example be stored in a memory accessible by an embedded digital signal processor in for example an eye glass frame 10 as disclosed in FIG. 1, and via a user interface it is possible for a user to select a desired set of FIR parameters.

With reference to FIG. 1, the illustrated eyeglass frame 10 is configured as disclosed above with a SOC system as well as a digital signal processor. Then by providing a correct command via for example a mobile phone in wireless communication with the SOC system, the SOC system and digital signal processor system can be initialized with the correct set of instructions and for example FIR coefficients controlling the output from the loudspeakers 16.

Other known loudspeaker beamforming algorithms may also be employed in embodiments of the present invention.

For example, a simpler known method of achieving a beam forming is a so called “Delay-and-Sum” (DAS) algorithm. A DAS beamformer may also comprise a near-field amplitude compensation provided by what is denoted qDAS filters.

The DAS method relies on constructive and destructive acoustic interference of the reproduced field at a desired location in space. The qDAS filters are designed such that the beamforming produces unitary pressure at point in space denoted as a bright point, i.e., the point in space the beam should provide a maximized power of the audio signal.

Other known loudspeaker beam forming methods usable within the context of the present invention is the Pressure Matching (PM) method, the Acoustic Contrast Maximization (ACM) method and the Energy Difference Maximization (EDM) method.

The article “Theoretical and experimental comparative analysis of beam forming methods for loudspeaker arrays under given performance constraints”, Journal of Sound and Vibration 373(9), March 2016 provides more details of respective beamforming algorithms.

According to an example of embodiment of the present invention, a head wearable carrier system 10, 19 is configured with a beam forming loudspeaker system 16, 16a, 16b, wherein the carrier system 10, 19 is configured to locate the beam forming loudspeaker system 16, 16a, 16b in proximity of a side of at least one ear 14 when in use, wherein beamformed audio signals 15 are directed towards an ear channel opening 18 of the at least one ear 14.

According to the example of embodiment disclosed above, respective loudspeaker systems 16, 16a, 16b are arranged as loudspeaker arrays comprising at least two loudspeakers.

According to the example of embodiment disclosed above, the carrier system 10, 19 may comprise a wireless interface enabling reception of wirelessly transmitted audio signals, wherein the respective loudspeaker system 16, 16a, 16b are configured to reproduce received audio signals.

According to the example of embodiment disclosed above, beamforming is provided by at least one configured digital signal processor (DSP) arranged in the head wearable carrier system 10, 19.

According to the example of embodiment disclosed above, the at least one digital signal processor is controlled by a configured system on a chip (SOC) arranged in the head wearable carrier system 19, 20.

According to the example of embodiment disclosed above, the configured system on a chip (SOC) initializes the at least one digital signal processor (DSP) with respective parameters of an implemented beam forming method providing a specific beam forming of the loudspeaker system.

According to the example of embodiment disclosed above, respective parameters providing a specific beam forming of the loudspeaker system is one of a set of different parameters providing different beam forming.

According to the example of embodiment disclosed above, the wearable carrier system is an eyeglass frame 10, wherein the loudspeaker system 16 is arranged in proximity of an end-area of at least one temple of the eyeglass frame 10.

According to the example of embodiment disclosed above, the wearable carrier system is a headset 19, wherein the loudspeaker system 16a, 16b is arranged on at least one support member 20, 21.

According to the example of embodiment disclosed above, the headset 19 comprises a microphone on an arm being connectable to the headset 19 enabling positioning of the microphone in front of a mouth of a user of the headset 19.

According to the example of embodiment disclosed above, the beamforming parameters of the at least one digital signal processor (DSP) are parameters adapted for a finite impulse response filter adapted to perform the beamforming.

According to the example of embodiment disclosed above, the beamforming parameters for the at least one digital signal processor (DSP) are parameters for a delay and sum method (DAS), or for a pressure matching filter (PM) method, or an Acoustic Contrast Maximization method.

1. A head wearable carrier system configured with at least one beam forming loudspeaker system
wherein the carrier system is configured to arrange the at least one beam forming loudspeaker system in proximity of a side of at least one ear when in use,
wherein beamformed audio signals are directed towards an ear channel opening of the at least one ear.

2. The system of claim 1, wherein respective loudspeaker systems are arranged as loudspeaker arrays comprising at least two loudspeakers.

3. The system of claim 1, wherein the carrier system comprises a wireless interface enabling reception of wirelessly transmitted audio signals, wherein respective loudspeaker systems are configured to reproduce the received audio signals.

4. The system of claim 1, wherein beamforming is provided by at least one configured digital signal processor (DSP) arranged in the head wearable carrier system.

5. The system of claim 4, wherein the at least one digital signal processor is controlled by a configured system on a chip (SOC) arranged in the head wearable carrier system.

6. The system of claim 5, wherein the configured system on a chip (SOC) initializes the at least one digital signal processor (DSP) with respective parameters providing a specific beam forming of the loudspeaker system.

6. The system of claim 6, wherein respective parameters providing a specific beam forming of the loudspeaker system is one of a set of different parameters providing different beam forming.

8. The system of claim 1, wherein the wearable carrier system is an eyeglass frame, wherein the at least one loudspeaker system is arranged in proximity of an end-area of at least one temple of the eyeglass frame.

9. The system of claim 1, wherein the wearable carrier system is a headset, wherein the at least one loudspeaker system is arranged on at least one support member in proximity of at least one side of an ear when the headset is attached to a head.

10. The system of claim 9, wherein the headset comprises a microphone on an arm being connectable to the headset enabling positioning of the microphone in front of a mouth of a user of the headset.

11. The system of claim 7, wherein the beamforming parameters of the at least one digital signal processor (DSP) are parameters adapted for a finite impulse response filter adapted to perform the beamforming.

12. The system of claim 7, wherein the beamforming parameters for the at least one digital signal processor (DSP) are parameters for a delay and sum method (DAS), or for a pressure matching filter (PM) method, or an Acoustic Contrast Maximization method.
